(19) United States
(12) Patent Application Publication
(10) Pub. No.: US 2025/0153200 A1
(43) Pub. Date: May 15, 2025

(54) WATER OUTLET DEVICE

(71) Applicant: FUJIAN XIHE SANITARY WARE TECHNOLOGY CO., LTD., Fujian (CN)

(72) Inventors: Xiaofa LIN, Fujian (CN); Xiaoshan LIN, Fujian (CN); Zhigang WAN, Fujian (CN); Pansheng LIANG, Fujian (CN); Xiaoqing DENG, Fujian (CN); Qiqiao LIU, Fujian (CN)

(73) Assignee: FUJIAN XIHE SANITARY WARE TECHNOLOGY CO., LTD., Fujian (CN)

(21) Appl. No.: 18/936,988

(22) Filed: Nov. 4, 2024

(30) Foreign Application Priority Data
Nov. 14, 2023 (CN) 202323073035.1

(51) Int. Cl. B05B 1/18; B05B 1/08; B05B 1/16

(52) U.S. Cl. CPC B05B 1/18; B05B 1/083; B05B 1/1627

(57) ABSTRACT

The disclosure provides a water outlet device, including a body, an impeller, a speed reducing member and a switching member. When in use, water enters a water passing chamber, and the impeller begins to rotate around a first axle line due to a hydraulic action, and at the same time drives the speed reducing member to revolve. Since outer gear teeth of the speed reducing member are engaged with inner gear teeth, the speed reducing member further rotates around a second axle line during the revolution, and the number of teeth of the outer gear teeth is less than the number of teeth of the inner gear teeth, thereby achieving a function of speed reduction. During the revolution of the speed reducing member, a driving shaft slides in a driving groove and abuts against a groove wall of the driving groove.

### CROSS-REFERENCE TO RELATED APPLICATION

This application claims the priority benefit of China application serial no. 202323073035.1, filed on Nov. 14, 2023. The entirety of the above-mentioned patent application is hereby incorporated by reference herein and made a part of this specification.

### BACKGROUND

### Technical Field

The disclosure relates to a field of a water outlet product, and more particularly, to a water outlet device.

### Description of Related Art

Existing massage showers usually achieve a massage function by impacting the body of the user with pressurized water flow. However, the water force of the pressurized water flow is relatively large. If the user does not move for a long time, the continuous impact will cause pain, affecting the user experience.

### SUMMARY

An objective of the disclosure is to overcome the above-mentioned defects or issues existing in the background by providing a water outlet device.

In order to achieve the above-mentioned objective, the following technical solutions are adopted for the disclosure and preferred embodiments thereof, but the embodiments are not limited to the following solutions.

Solution 1: A water outlet device, including:
a body provided with a water passing chamber and a water outlet, in which the water passing chamber is provided with a water passing port connected to the water outlet, an inner wall of the water passing chamber is provided with multiple inner gear teeth, and each of the inner gear teeth is disposed around a first axle line extending along a first direction;
an impeller disposed in the water passing chamber, rotatably connected to the body about the first axle line and adapted to rotate when water enters the water passing chamber, and provided with an eccentric shaft extending along the first direction and along a second axle line parallel to the first axle line;
a speed reducing member disposed in the water passing chamber, rotatably connected to the eccentric shaft, and provided with multiple outer gear teeth adapted to be engaged with the inner gear teeth, in which each of the outer gear teeth is disposed around the second axle line, a number of teeth of the outer gear teeth is less than a number of teeth of the inner gear teeth, and the speed reducing member is further provided with a driving shaft extending along the first direction;
a switching member disposed in the water passing chamber and sliding and cooperating with the body along a second direction perpendicular to the first axle line, and provided with a blocking portion, in which the blocking portion is attached to a surface where the water passing port is located, the switching member is provided with a driving groove extending in a direction perpendicular to the second direction and the first axle line, and the driving shaft is adapted to extend into the driving groove and abutting against a groove wall of the driving groove, so that the blocking portion slides repeatedly relative to the body along the second direction to change a water passing area of the water passing port.

Solution 2: A water outlet device, including:
a body provided with a water passing chamber and a water outlet, in which the water passing chamber is provided with a water passing port connected to the water outlet, an inner wall of the water passing chamber is provided with multiple inner gear teeth, and each of the inner gear teeth is disposed around a first axle line;
an impeller rotatably connected to the body around the first axle line and adapted to rotate when water enters the water passing chamber, and provided with an eccentric shaft extending along a second axle line parallel to the first axle line;
a speed reducing member rotatably connected to the eccentric shaft, and provided with multiple outer gear teeth adapted to be engaged with the inner gear teeth, in which a number of teeth of the outer gear teeth is less than a number of teeth of the inner gear teeth, the speed reducing member is further provided with a blocking portion, and the blocking portion is attached to a surface where the water passing port is located and is adapted to move relative to the body to change a water passing area of the water passing port.

Solution 3: Based on Solution 1 or 2, the number of teeth of the outer gear is one less than the number of teeth of the inner gear.

Solution 4: Based on Solution 1 or 2, the body is provided with at least a first annular water channel, a second annular water channel, a third annular water channel, and a fourth annular water channel. The first annular water channel, the second annular water channel, the third annular water channel, and the fourth annular water channel are all provided with the water outlets. The water passing port at least includes a first water passing port and a second water passing port. Each of the water passing ports is disposed on a sliding path of the blocking portion. The first water passing port is adapted to be connected to the first annular water channel and the third annular water channel, and the second water passing port is connected to the second annular water channel and the fourth annular water channel.

Solution 5: Based on Solution 4, the body includes a water distribution plate. The water distribution plate is provided with at least a first water passing channel and a second water passing channel respectively connected to the first water passing port and the second water passing port. The first water passing channel is provided with a first water through hole and a second water through hole respectively connected to the first annular water channel and the third annular water channel, and the second water passing channel is provided with a third water through hole and a fourth water through hole respectively connected to the second annular water channel and the fourth annular water channel.

Solution 6: Based on Solution 4, the first annular water channel is connected to the third annular water channel, and the second annular water channel is connected to the fourth annular water channel.

Solution 7: Based on Solution 1 or 2, the driving shaft extends in a direction parallel to the second axle line.

Solution 8: Based on Solution 1 or 2, the body is provided with multiple inclined water holes, the inclined water holes are connected to the water passing chamber, and a water outlet direction faces toward blades of the impeller.

Solution 9: Based on Solution 1 or 2, the speed reducing member is further provided with multiple water passing holes.

Solution 10: Based on Solution 1 or 2, the body includes a water inlet member, an water inclining body, a housing, a water distribution plate, and a water outlet panel. The water inlet member is provided with a water inlet. The housing is provided with a seating surface with an opening on the water passing chamber on the seating surface. The water inclining body is seated on the seating surface. The water inlet member is seated on the water inclining body and is fixedly connected to the housing. The water inclining body is provided with multiple inclined water holes. A water inlet end and a water outlet end of the inclined water hole are respectively connected to the water inlet and the water passing chamber such that the impeller rotates. The housing is further provided with an installation groove. The water distribution plate is disposed in the installation groove and is provided with a water passing channel connected to the water passing port. The water outlet panel is provided with the water outlet connected to the water passing channel, and the water outlet panel is fixedly connected to the housing and abuts against the water distribution plate, so that two sides of the water distribution plate are respectively limited by the water outlet panel and a groove bottom of the installation groove.

According to the above descriptions of the disclosure and preferred embodiments thereof, compared to the related art, the technical solutions of the disclosure and the preferred embodiments thereof have the following beneficial effects due to the adoption of the following technical means.

1. In Solution 1 and the preferred embodiment thereof, when in use, the water enters the water passing chamber, and the impeller begins to rotate around the first axle line due to a hydraulic action, and at the same time drives the speed reducing member to revolve around the first axle line. Since the outer gear teeth of the speed reducing member are engaged with the inner gear teeth, the speed reducing member further rotates around the second axle line during the revolution, and the number of teeth of the outer gear teeth is less than the number of teeth of the inner gear teeth. When the impeller drives the speed reducing member to revolve, each of the teeth of the outer gear teeth is required to be engaged with each of the teeth of the inner gear teeth once, and the time for one rotation of the speed reducing member will be greater than the time for one rotation of the impeller. A speed reducing magnification is 1/the number of inner gear teeth, thereby achieving a function of speed reduction.

During the revolution of the speed reducing member, the driving shaft slides in the driving groove and abuts against the groove wall of the driving groove, so that the switching member repeatedly slides relative to the body along the second direction, thereby changing the water passing area of the water passing port and finally changing the flow rate of the water outlet to achieve intermittent massage. The water flow will not be directed to one part of the body of the user with maximum hydraulic force for a long time, reducing the pain of massage. In addition, after speed reduction by the speed reducing member, a change process is relatively slow, and the user may feel the change, which enhances the massage experience of the user.

2. In Solution 2 and the preferred embodiment thereof, when in use, the water enters the water passing chamber, and the impeller begins to rotate around the first axle line due to the hydraulic action, and at the same time drives the speed reducing member to revolve. Since the outer gear teeth of the speed reducing member are engaged with the inner gear teeth, the speed reducing member further rotates around the second axle line during the revolution, and the number of teeth of the outer gear teeth is less than the number of teeth of the inner gear teeth, thereby achieving the function of speed reduction. During the revolution of the speed reducing member, the blocking portion moves relative to the body to change the water passing area of the water passing port, thereby achieving the change in the water path and/or the water volume.

3. In Solution 3 and the preferred embodiment thereof, the number of teeth of the outer gear is one less than the number of teeth of the inner gear, thereby ensuring speed reduction while preventing an issue of poor engagement caused by excessive difference in the number of teeth.

4. In Solution 4 and the preferred embodiment thereof, in this embodiment, since there are two water outlets, the sliding of the switching member may further achieve a function of switching the water paths, and may achieve two water outlet methods, which are water outlet of the first annular water channel and the third annular water channel, and water outlet of the second annular water channel and the fourth annular water channel, which have more diverse functions.

5. In Solution 5 and the preferred embodiment thereof, the first water passing channel and the second water passing channel respectively connected to the first water passing port and the second water passing port are provided through a water distribution plate. The first water passing channel is provided with the first water through hole and the second water through hole respectively connected to the first annular water channel and the third annular water channel, and the second water passing channel is provided with the third water through hole and the fourth water through hole respectively connected to the second annular water channel and the fourth annular water channel, thereby achieving the two water outlet methods and ensuring as much as possible the simultaneous water outlet of the first annular water channel and the third annular water channel, and the simultaneous water outlet of the second annular water channel and the fourth annular water channel.

6. In Solution 6 and the preferred embodiment thereof, the first annular water channel is connected to the third annular water channel, and the second annular water channel is connected to the fourth annular water channel, such structure may enable the water in the first water passing port to enter the first annular water channel and the third annular water channel and the water in the second water passing port to enter the second annular water channel and the fourth annular water channel without disposing the water distribution plate, in which the structure is simple.

7. In Solution 7 and the preferred embodiment thereof, when the driving shaft extends along the second axle line, although the driving shaft may also enable the switching member to slide by abutting against the groove wall of the driving groove when the speed reducing member revolves around the first axle line, a sliding distance of the switching member is small. In order to enable the sliding distance of the switching member to be greater, in this embodiment, the driving shaft extends in the direction parallel to the second axle line, so that a movement range of the driving shaft is greater, and when the speed reducing member rotates, the position of the driving shaft will also change, so that the sliding distance of the switching member is greater, which makes it convenient to dispose more water passing ports on the body and achieve more functions.

8. In Solution 8 and the preferred embodiment thereof, the body is provided with a plurality of inclined water holes. The inclined water holes are connected to the water passing chamber, and the water outlet direction faces toward the blades of the impeller, thereby achieving the rotation of the impeller without the need for electricity to drive the impeller, which saves more energy.

9. In Solution 9 and the preferred embodiment thereof, although a gap between the inner gear teeth and the outer gear teeth may allow the water to flow to the switching member, the amount of water passing through is small, which will affect normal water outflow of the water outlet. In order to increase the amount of water passing through, the speed reducing member is further provided with the water passing holes, which may increase the amount of water passing through.

10. In Solution 10 and the preferred embodiment thereof, the body includes the water inlet member, the water inclining body, the housing, the water distribution plate, and the water outlet panel. The water inlet member is provided with the water inlet. The housing is provided with the seating surface and the water passing chamber with the opening on the seating surface. The water inclining body is seated on the seating surface. The water inlet member is seated on the water inclining body and is fixedly connected to the housing. The water inclining body is provided with a plurality of inclined water holes. The water inlet end and the water outlet end of the inclined water hole are respectively connected to the water inlet and the water passing chamber such that the impeller rotates. The housing is further provided with the installation groove. The water distribution plate is disposed in the installation groove and is provided with the water passing channel connected to the water passing port. The water outlet panel is provided with the water outlet connected to the water passing channel, and the water outlet panel is fixedly connected to the housing and abuts against the water distribution plate, so that the two sides of the water distribution plate are respectively limited by the water outlet panel and the groove bottom of the installation groove. The body is split into multiple components, which is helpful for manufacturing and processing.

### BRIEF DESCRIPTION OF THE DRAWINGS

In order to more clearly illustrate technical solutions of embodiments of the disclosure, the following is a brief introduction to the drawings required for use in the description of the embodiments. Obviously, the drawings described below are some embodiments of the disclosure. For those of ordinary skill in the art, other drawings may be further obtained based on these drawings without exerting creative efforts.

FIG. 1 is a bottom view of a water outlet device in the first embodiment.

FIG. 2 is a cross-sectional view of a cut surface shown in FIG. 1.

FIG. 3 is an exploded view of the water outlet device in the first embodiment.

FIG. 4 is a perspective view of a housing in the first embodiment.

FIG. 5 is a perspective view of a water distribution plate in the first embodiment.

FIG. 6 is a perspective view of a water outlet panel in the first embodiment.

FIG. 7 is a perspective view of an impeller in the first embodiment.

FIG. 8 is a perspective view of a speed reducing member in the first embodiment when viewed from above.

FIG. 9 is a perspective view of the speed reducing member in the first embodiment when viewed from bottom.

FIG. 10 is a perspective view of a switching member in the first embodiment.

FIG. 11 is a schematic view of assembly of the switching member and the housing in the first embodiment.

FIG. 12 is an exploded view of a water outlet device in the second embodiment.

FIG. 13 is a schematic view of a structure of the water outlet device in the second embodiment.

### DETAILED DESCRIPTION OF DISCLOSED EMBODIMENTS

Technical solutions in the embodiments of the disclosure will be described clearly and completely below in conjunction with the accompanying drawings in the embodiments of the disclosure. Obviously, the described embodiments are preferred embodiments of the disclosure and should not be considered as excluding other embodiments. Based on the embodiments of the disclosure, all other embodiments obtained by those of ordinary skill in the art without exerting any creative efforts shall fall within the scope of the disclosure.

In the claims, specification, and above-mentioned drawings of the disclosure, unless otherwise clearly defined, the use of terms, such as “first”, “second”, “third” etc. are for distinguishing different objects rather than for describing a specific order.

In the claims, specification, and above-mentioned drawings of the disclosure, unless otherwise clearly defined, directional terms, such as the terms “central”, “lateral”, “longitudinal”, “horizontal”, “vertical”, “top”, “bottom”, “inside”, “outside”, “up”, “down”, “front”, “back”, “left”, “right”, “clockwise”, “counterclockwise”, etc., indicating directions or positional relationships are based on directions and positional relationships shown in the drawings, and are only for convenience of describing the disclosure and simplifying the description, rather than indicating or implying that the device or element referred to must have a specific direction or be constructed and operated in a specific direction. Therefore, it cannot be understood as limiting the specific scope of the disclosure.

In the claims, specification, and above-mentioned drawings of the disclosure, unless otherwise clearly defined, if the term, “fixing” or “fixed connection”, is used, it should be understood in a broad sense, that is, any connection method without a displacement relationship and relative rotation relationship between the two, that is to say, including non-detachable fixed connection, detachable fixed connection, integrated connection, and fixed connection through other devices or elements.

In the claims, specification, and above-mentioned drawings of the disclosure, if the terms, “including”, “having”, and variations thereof are used, they are intended to mean “including but not limited to”.

### First Embodiment

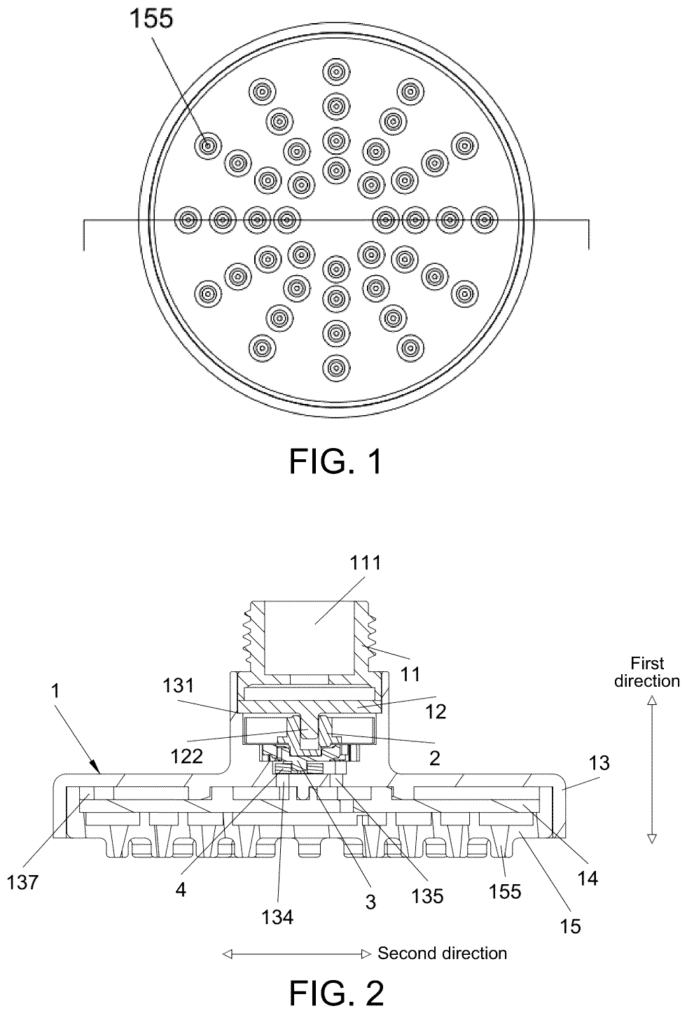

Referring to FIGS. 1 to 11, a water outlet device includes a body 1, an impeller 2, a speed reducing member 3, and a switching member 4.

Referring to FIG. 2, the body 1 includes a water inlet member 11, a water inclining body 12, a housing 13, a water distribution plate 14, and a water outlet panel 15.

The water inlet member 11 is provided with a water inlet 111.

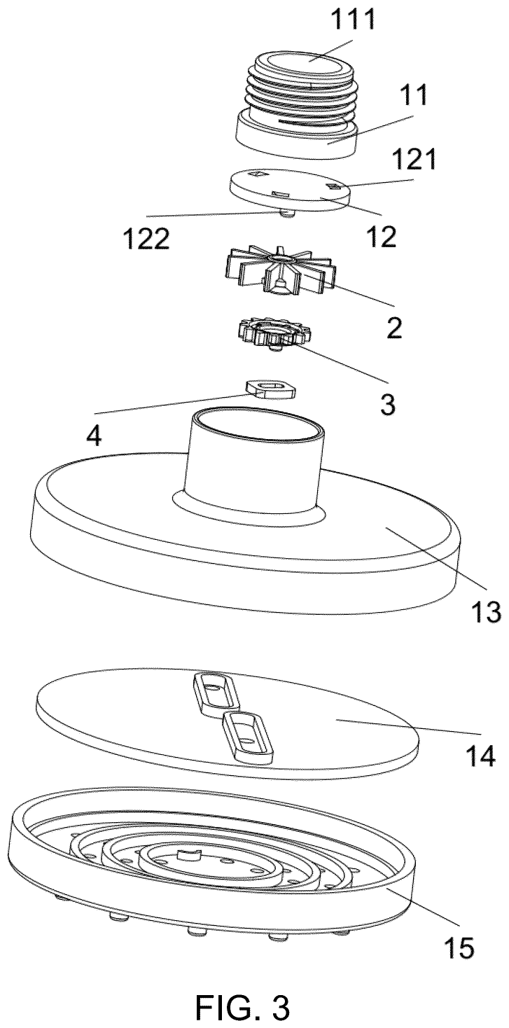

Referring to FIG. 3, the water inclining body 12 is provided with multiple inclined water holes 121. The water inclining body 12 is further provided with a rotating column 122, and a central axis of the rotating column 122 is a first axle line extending along a first direction.

In this embodiment, the first direction is an up-down direction in FIG. 2, and the water inlet member 11 is located on an upper side of the water outlet panel 15. The rotating column 122 is located in the middle of the water inclining body 12, and the inclined water hole 121 is disposed around the rotating column 122.

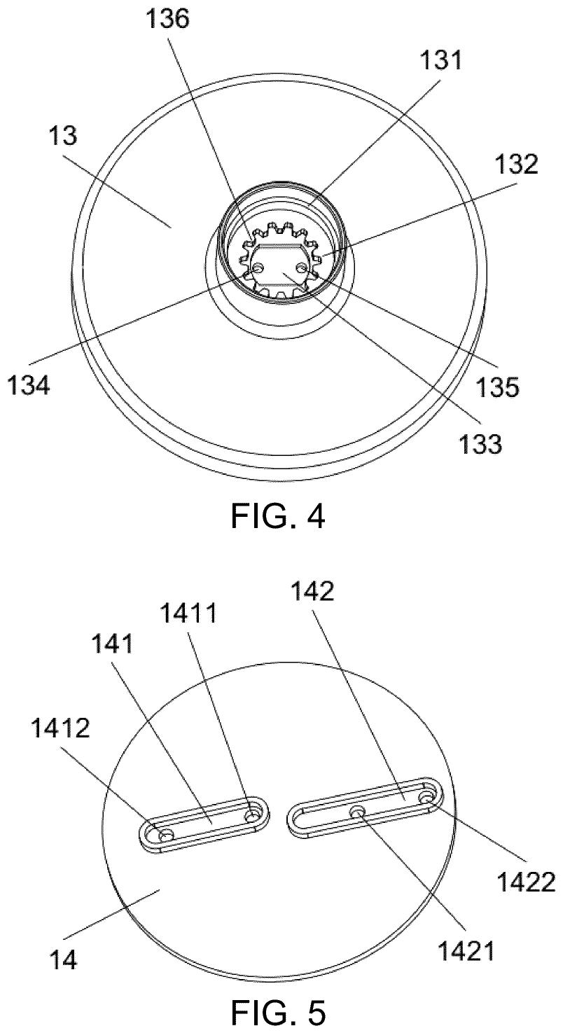

Referring to FIG. 4, the housing 13 is provided with a seating surface 131 and a water passing chamber 132 with an opening on the seating surface 131. Referring to FIG. 2, the water inclining body 12 is seated on the seating surface 131, the water inlet member 11 is seated on the water inclining body 12 and is in threaded connection with the housing 13, and a water inlet end and a water outlet end of the inclined water hole 121 are respectively connected to the water inlet 111 and the water passing chamber 132.

Referring to FIG. 4, a sliding groove 133 is disposed on one side of the water passing chamber 132 away from the water inclining body 12, and a water passing port is disposed at a groove bottom of the sliding groove 133. In this embodiment, there are two water passing ports, which are a first water passing port 134 and a second water passing port 135 respectively. Multiple inner gear teeth 136 are disposed on an inner wall of the water passing chamber 132.

Each of the inner gear teeth 136 is disposed around the first axle line and protrudes from the inner wall of the water passing chamber 132 toward the first axle line. Optionally, the number of teeth of the inner gear teeth 136 is 11 to 15. Referring to FIG. 2, the housing 13 is further provided with an installation groove 137. A groove opening of the installation groove 137 is away from the water passing chamber 132, and the installation groove 137 is connected to the water passing port of the water passing chamber 132, so that a water path on the water distribution plate 14 subsequently disposed in the installation groove 137 is connected to the water passing port.

Referring to FIG. 2, the water distribution plate 14 is disposed in the installation groove 137. Referring to FIG. 5, the water distribution plate 14 is provided with at least a first water passing channel 141 and a second water passing channel 142 respectively connected to the first water passing port 134 and the second water passing port 135. The first water passing channel 141 is provided with a first water through hole 1411 and a second water through hole 1412. The second water passing channel 142 is provided with a third water through hole 1421 and a fourth water through hole 1422.

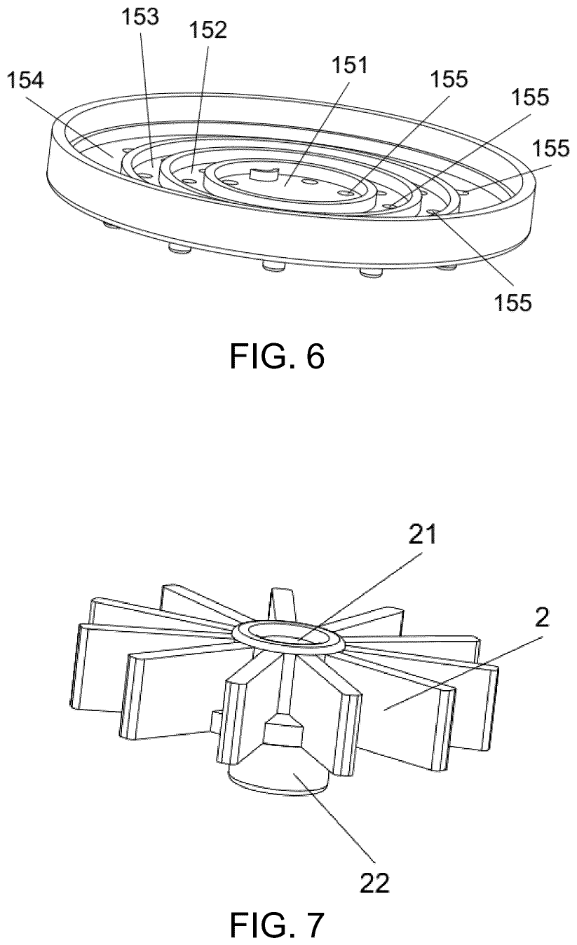

Referring to FIG. 6, the water outlet panel 15 is provided with a first annular water channel 151, a second annular water channel 152, a third annular water channel 153, and a fourth annular water channel 154 which are disposed in concentric circles. Circle diameters of the first annular water channel 151, the second annular water channel 152, the third annular water channel 153, and the fourth annular water channel 154 increase sequentially. The first annular water channel 151, the second annular water channel 152, the third annular water channel 153, and the fourth annular water channel 154 are all provided with multiple water outlets 155. The first annular water channel 151 and the third annular water channel 153 are connected to the first water through hole 1411 and the second water through hole 1412 respectively, and the second annular water channel 152 and the fourth annular water channel 154 are connected to the third water through hole 1421 and the fourth water through hole 1422 respectively.

Referring to FIG. 2, the water outlet panel 15 is in threaded connection with a groove wall of the installation groove 137 and abuts against the water distribution plate 14, so that two sides of the water distribution plate 14 are respectively limited by the water outlet panel 15 and a groove bottom of the installation groove 137.

The impeller 2 is disposed in the water passing chamber 132. Referring to FIG. 7, the impeller 2 is provided with a rotating groove 21, and the rotating groove 21 is connected to the rotating column 122 for rotation around the first axle line. A water outlet direction of the inclined water hole 121 faces toward blades of the impeller 2, so that the impeller 2 rotates when water enters the water passing chamber 132 without the need for electricity to drive the impeller 2, which saves more energy. The impeller 2 is provided with an eccentric shaft 22 extending along a first direction and a second axle line parallel to the first axle line.

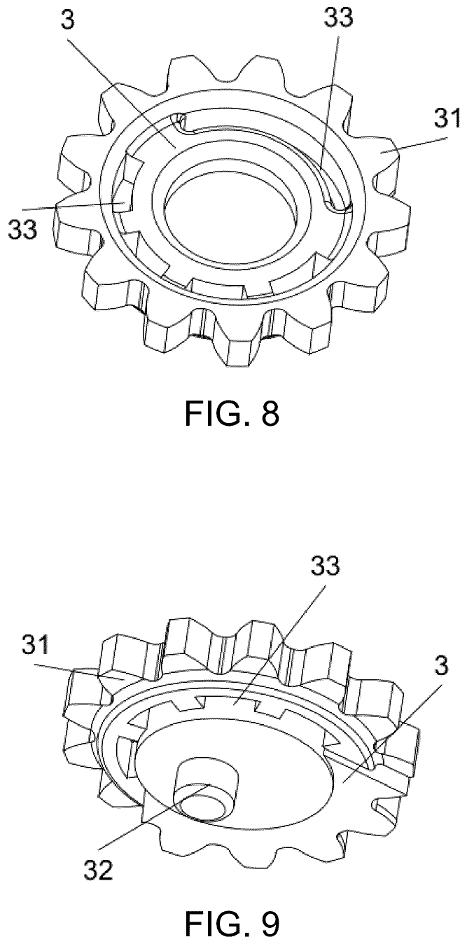

The speed reducing member 3 is disposed in the water passing chamber 132, and the speed reducing member 3 is connected to the eccentric shaft 22 for rotation around the second axle line. Referring to FIG. 8, the speed reducing member 3 is provided with multiple outer gear teeth 31 adapted to be engaged with the inner gear teeth 136, and each of the outer gear teeth 31 is disposed around the second axle line (a distance between each of the outer gear teeth 31 and the second axle line is equal). Specifically, the outer gear teeth 31 protrude outward from an outer wall of the speed reducing member 3 in a direction away from the second axle line, and the number of teeth of the outer gear teeth 31 is less than the number of teeth of the inner gear teeth 136, so as to achieve a speed reducing effect. The number of teeth of the outer gear teeth 31 is one less than the number of teeth of the inner gear teeth 136, which ensures speed reduction while preventing an issue of poor engagement caused by excessive difference in the number of teeth. In this embodiment, the number of teeth of the inner gear teeth 136 is 14, and the number of teeth of the outer gear teeth 31 is 13.

Referring to FIG. 9, the speed reducing member 3 is further provided with a driving shaft 32 extending along the first direction. In this embodiment, the driving shaft 32 extends along a direction parallel to the second axle line. Although a gap between the inner gear teeth 136 and the outer gear teeth 31 may allow the water to flow to the switching member 4, the amount of water passing through is small, which will affect normal water outflow of the water outlet 155. In order to increase the amount of water passing through, the speed reducing member 3 is further provided with multiple water passing holes 33 passing through the speed reducing member 3 in a direction parallel to the second axle line, which may increase the amount of water passing through. Of course, the water passing holes 33 may further extend in other directions.

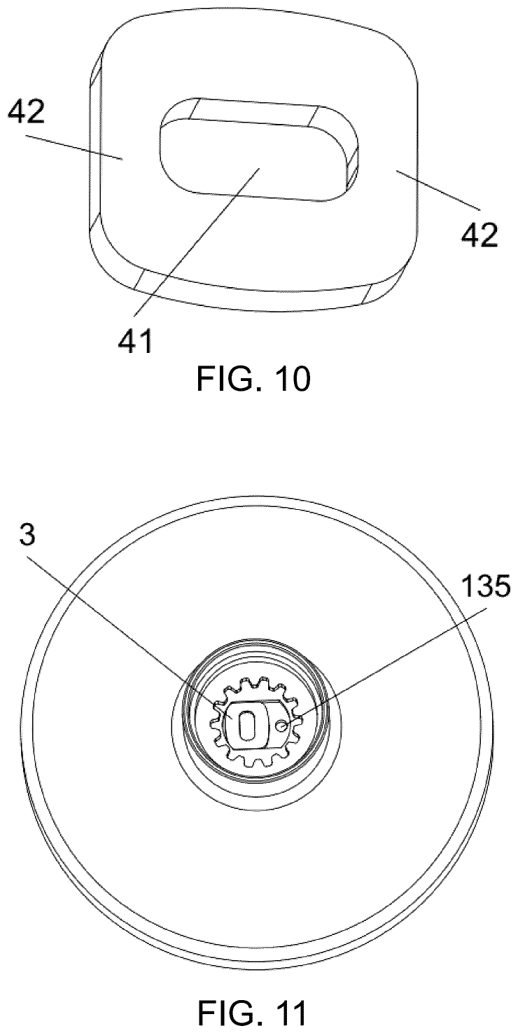

Referring to FIG. 11, the switching member 4 is disposed in the sliding groove 133 of the water passing chamber 132 and slides and cooperates with the sliding groove 133 along a second direction perpendicular to the first axle line. The second direction is a left-right direction in FIG. 2. Referring to FIG. 10, the switching member 4 is provided with a blocking portion 42, and the blocking portion 42 is attached to a surface where the water passing port is located. In this embodiment, the blocking portion 42 is attached to the groove bottom of the sliding groove 133. The switching member 4 is provided with a driving groove 41 extending in a direction perpendicular to the second direction and the first axle line, and the driving shaft 32 is adapted to extend into the driving groove 41. When a position of the driving shaft 32 along the second direction changes, the driving shaft 32 abuts against a groove wall of the driving groove 41, so that the blocking portion 42 slides repeatedly relative to the body 1 along the second direction to change a water passing area of the first water passing port 134 and the second water passing port 135.

When in use, referring to FIG. 2, the water enters the water passing chamber 132 from the water inlet 111 and the inclined water hole 121, and the impeller 2 begins to rotate around the first axle line due to a hydraulic action, and at the same time drives the speed reducing member 3 to revolve around the first axle line. Since the outer gear teeth 31 of the speed reducing member 3 are engaged with the inner gear teeth 136, the speed reducing member 3 further rotates around the second axle line, and the number of teeth of the outer gear teeth 31 is less than the number of teeth of the inner gear teeth 136. When the impeller 2 drives the speed reducing member 3 to revolve, each of the teeth of the outer gear teeth 31 is required to be engaged with each of the teeth of the inner gear teeth 136 once, and the time for one rotation of the speed reducing member 3 will be greater than the time for one rotation of the impeller 2. A speed reducing magnification is 1/the number of inner gear teeth 136, thereby achieving a function of speed reduction.

During the revolution of the speed reducing member 3, the position of the driving shaft 32 along the second direction and a direction perpendicular to the first direction and the second direction changes. Therefore, while the driving shaft 32 slides in the driving groove 41 in the direction perpendicular to the first direction and the second direction, it abuts against the groove wall of the driving groove 41 in the second direction, causing the switching member 4 to slides repeatedly relative to the body 1 in the second direction, thus changing the water passing areas of the first water passing port 134 and the second water passing port 135. When the water passes through the first water passing port 134, the water enters the first water passing channel 141 and is distributed to two water outlets through two water paths, which are from the first water through hole 1411 and the first annular water channel 151 to the water outlet, and from the second water through hole 1412 and the third annular water channel 153 to the water outlet; when the water passes through the second water passing port 135, the water enters the second water passing channel 142 and is distributed to two water outlets through two water paths, which are from the third water through hole 1421 and the second annular water channel 152 to the water outlet, and from the fourth water through hole 1422, and the fourth annular water channel 154 to the water outlet, so that the functions are more diverse. After speed reduction by the speed reducing member 3, a change process is slower, and the user may feel the change, thus improving the user experience.

Of course, by designing a size of the blocking portion 42, it is also possible to achieve a situation where the water can pass through the first water passing port 134 and the second water passing port 135 at the same time.

When the driving shaft 32 extends along the second axle line, although the driving shaft 32 may also enable the switching member 4 to slide by abutting against the groove wall of the driving groove 41 when the speed reducing member 3 revolves around the first axle line, a sliding distance of the switching member 4 is small. In order to enable the sliding distance of the switching member 4 to be greater, in this embodiment, the driving shaft 32 extends in the direction parallel to the second axle line, so that when the speed reducing member 3 rotates, the position of the driving shaft 32 will also change, and a movement range of the driving shaft 32 is greater, so that the sliding distance of the switching member 4 is greater, which makes it convenient to dispose more water passing ports on the body 1 and achieve more functions.

Due to the speed reduction of the speed reducing member 3, the above-mentioned water path changes slowly, and the user may feel the change of the water path, thereby enhancing the massage experience of the user. At the same time, the water path and water volume change constantly to achieve intermittent massage, which will not cause pain to the user due to long-term water discharge to the same part of the body of the user.

In other embodiments, the number of water outlets may be only one, or more than two, and each of the water outlets is disposed on a sliding path of the switching member 4 to achieve the change of the water path. When there is only one water outlet, a main function of the blocking portion 42 is to change the water output.

In other embodiments, the water distribution plate 14 may not be disposed. The first water passing port 134 is connected to the first annular water channel 151 or the third annular water channel 153. The first annular water channel 151 is connected to the third annular water channel 153. The second water passing port 135 is connected to the second annular water channel 152 or the fourth annular water channel 154. The second annular water channel 152 is connected to the fourth annular water channel 154. The structure may enable the water in the first water passing port 134 to enter the first annular water channel 151 and the third annular water channel 153 and the water in the second water passing port 135 to enter the second annular water channel 152 and the fourth annular water channel 154 without disposing the water distribution plate 14, in which the structure is simple.

### Second Embodiment

This embodiment is different from the first embodiment in that in this embodiment, there is no switching member 4, and a function of the switching member 4 is directly achieved by the speed reducing member 3.

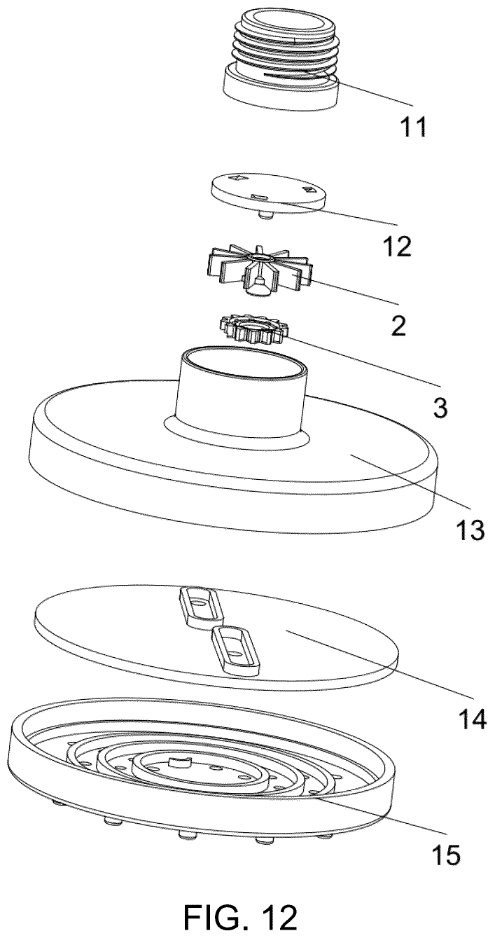

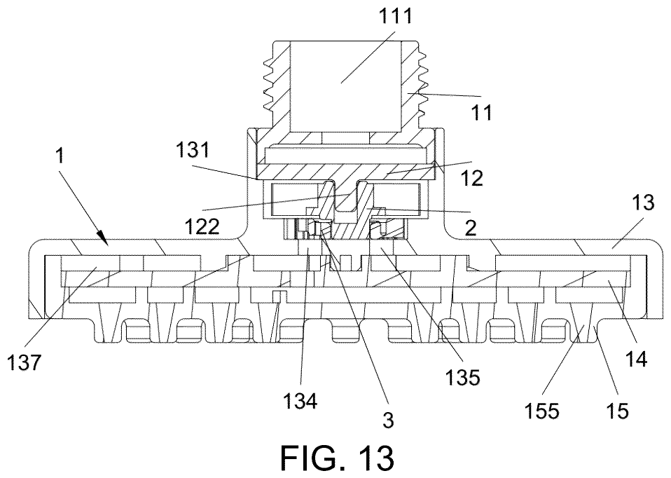

Referring to FIGS. 12 and 13, specifically, a water outlet device includes the body 1, the impeller 2, and a speed reducing member 3.

The body 1 is provided with a water passing chamber 132 and a water outlet 155. The water passing chamber 132 is provided with a water passing port connected to the water outlet 155. The inner wall of the water passing chamber 132 is provided with the inner gear teeth 136. Each of the inner gear teeth 136 is disposed around the first axle line.

The impeller 2 is connected to the body 1 for rotation around the first axle line, and is adapted to rotate when the water enters the water passing chamber 132. The impeller 2 is provided with the eccentric shaft 22 extending along the second axle line parallel to the first axle line.

The speed reducing member 3 is rotatably connected to the eccentric shaft 22. The speed reducing member 3 is provided with the outer gear teeth 31 adapted to be engaged with the inner gear teeth 136. The number of teeth of the outer gear teeth 31 is less than the number of teeth of the inner gear teeth 136. The speed reducing member 3 is further provided with the blocking portion 42, and the blocking portion 42 is attached to the surface where the water passing port is located and is suitable for moving relative to the body 1 to change the water passing area of the water passing port.

When in use, the water enters the water passing chamber 132, and the impeller 2 begins to rotate around the first axle line due to the hydraulic action, and at the same time drives the speed reducing member 3 to revolve around the first axle line. Since the outer gear teeth 31 of the speed reducing member 3 are engaged with the inner gear teeth 136, the speed reducing member 3 further rotates around the second axle line during the revolution, and the number of teeth of the outer gear teeth 31 is less than the number of teeth of the inner gear teeth 136, thereby achieving the function of speed reduction. During the revolution of the speed reducing member 3, the blocking portion 42 moves relative to the body 1 to change the water passing area of the water passing port, thereby achieving the change in the water path and/or the water volume, and achieving intermittent massage. The change in the water path may be achieved by disposing the water passing ports on a movement path of the blocking portion 42.

The description of the above specification and embodiments are used to explain the scope of the disclosure, but does not constitute a limitation on the scope of the disclosure. Through the enlightenment of the disclosure or the above-mentioned embodiments, those of ordinary skill in the art, combined with common knowledge, ordinary technical knowledge in the art and/or existing technologies, may obtain modifications, equivalent substitutions, or other improvements to the embodiments of the disclosure or part of the technical features through logical analysis, reasoning, or limited experiments, which should be included in the scope of the disclosure.

What is claimed is:

1. A water outlet device, comprising:
a body provided with a water passing chamber and a water outlet, wherein the water passing chamber is provided with a water passing port connected to the water outlet, an inner wall of the water passing chamber is provided with a plurality of inner gear teeth, and each of the inner gear teeth is disposed around a first axle line extending along a first direction;
an impeller disposed in the water passing chamber, rotatably connected to the body around the first axle line and adapted to rotate when water enters the water passing chamber, and provided with an eccentric shaft extending along the first direction and along a second axle line parallel to the first axle line;
a speed reducing member disposed in the water passing chamber, rotatably connected to the eccentric shaft, and provided with a plurality of outer gear teeth adapted to be engaged with the inner gear teeth, wherein each of the outer gear teeth is disposed around the second axle line, a number of teeth of the outer gear teeth is less than a number of teeth of the inner gear teeth, and the speed reducing member is further provided with a driving shaft extending along the first direction; and
a switching member disposed in the water passing chamber and sliding and cooperating with the body along a second direction perpendicular to the first axle line, and provided with a blocking portion, wherein the blocking portion is attached to a surface where the water passing port is located, the switching member is provided with a driving groove extending in a direction perpendicular to the second direction and the first axle line, and the driving shaft is adapted to extend into the driving groove and abut against a groove wall of the driving groove, so that the blocking portion slides repeatedly relative to the body along the second direction to change a water passing area of the water passing port.

2. A water outlet device, comprising:
a body provided with a water passing chamber and a water outlet, wherein the water passing chamber is provided with a water passing port connected to the water outlet, an inner wall of the water passing chamber is provided with a plurality of inner gear teeth, and each of the inner gear teeth is disposed around a first axle line;
an impeller rotatably connected to the body around the first axle line and adapted to rotate when water enters the water passing chamber, and provided with an eccentric shaft extending along a second axle line parallel to the first axle line; and
a speed reducing member rotatably connected to the eccentric shaft, and provided with a plurality of outer gear teeth adapted to be engaged with the inner gear teeth, wherein a number of teeth of the outer gear teeth is less than a number of teeth of the inner gear teeth, the speed reducing member is further provided with a blocking portion, and the blocking portion is attached to a surface where the water passing port is located and is adapted to move relative to the body to change a water passing area of the water passing port.

3. The water outlet device according to claim 1, wherein the number of teeth of the outer gear is one less than the number of teeth of the inner gear.

4. The water outlet device according to claim 1, wherein the body is provided with at least a first annular water channel, a second annular water channel, a third annular water channel, and a fourth annular water channel, the first annular water channel, the second annular water channel, the third annular water channel, and the fourth annular water channel are all provided with the water outlets, the water passing port at least comprises a first water passing port and a second water passing port, each of the water passing ports is disposed on a sliding path of the blocking portion, the first water passing port is adapted to be connected to the first annular water channel and the third annular water channel, and the second water passing port is connected to the second annular water channel and the fourth annular water channel.

5. The water outlet device according to claim 4, wherein the body comprises a water distribution plate, the water distribution plate is provided with at least a first water passing channel and a second water passing channel respectively connected to the first water passing port and the second water passing port, the first water passing channel is provided with a first water through hole and a second water through hole respectively connected to the first annular water channel and the third annular water channel, and the second water passing channel is provided with a third water through hole and a fourth water through hole respectively connected to the second annular water channel and the fourth annular water channel.

6. The water outlet device according to claim 4, wherein the first annular water channel is connected to the third annular water channel, and the second annular water channel is connected to the fourth annular water channel.

7. The water outlet device according to claim 1, wherein the driving shaft extends in a direction parallel to the second axle line.

8. The water outlet device according to claim 1, wherein the body is provided with a plurality of inclined water holes, the inclined water holes are connected to the water passing chamber, and a water outlet direction faces toward blades of the impeller.

9. The water outlet device according to claim 1, wherein the speed reducing member is further provided with a plurality of water passing holes.

10. The water outlet device according to claim 1, wherein the body comprises a water inlet member, a water inclining body, a housing, a water distribution plate, and a water outlet panel, the water inlet member is provided with a water inlet, the housing is provided with a seating surface and the water passing chamber (132) with an opening on the seating surface, the water inclining body is seated on the seating surface, the water inlet member is seated on the water inclining body and is fixedly connected to the housing, the water inclining body is provided with a plurality of inclined water holes, a water inlet end and a water outlet end of the inclined water hole are respectively connected to the water inlet and the water passing chamber such that the impeller rotates, the housing is further provided with an installation groove, the water distribution plate is disposed in the installation groove and is provided with a water passing channel connected to the water passing port, the water outlet panel is provided with the water outlet connected to the water passing channel, and the water outlet panel is fixedly connected to the housing and abuts against the water distribution plate, so that two sides of the water distribution plate are respectively limited by the water outlet panel and a groove bottom of the installation groove.

11. The water outlet device according to claim 2, wherein the number of teeth of the outer gear is one less than the number of teeth of the inner gear.

12. The water outlet device according to claim 2, wherein the body is provided with at least a first annular water channel, a second annular water channel, a third annular water channel, and a fourth annular water channel, the first annular water channel, the second annular water channel, the third annular water channel, and the fourth annular water channel are all provided with the water outlets, the water passing port at least comprises a first water passing port and a second water passing port, each of the water passing ports is disposed on a sliding path of the blocking portion, the first water passing port is adapted to be connected to the first annular water channel and the third annular water channel, and the second water passing port is connected to the second annular water channel and the fourth annular water channel.

13. The water outlet device according to claim 12, wherein the body comprises a water distribution plate, the water distribution plate is provided with at least a first water passing channel and a second water passing channel respectively connected to the first water passing port and the second water passing port, the first water passing channel is provided with a first water through hole and a second water through hole respectively connected to the first annular water channel and the third annular water channel, and the second water passing channel is provided with a third water through hole and a fourth water through hole respectively connected to the second annular water channel and the fourth annular water channel.

14. The water outlet device according to claim 12, wherein the first annular water channel is connected to the third annular water channel, and the second annular water channel is connected to the fourth annular water channel.

15. The water outlet device according to claim 2, wherein the driving shaft extends in a direction parallel to the second axle line.

16. The water outlet device according to claim 2, wherein the body is provided with a plurality of inclined water holes, the inclined water holes are connected to the water passing chamber, and a water outlet direction faces toward blades of the impeller.

17. The water outlet device according to claim 2, wherein the speed reducing member is further provided with a plurality of water passing holes.

18. The water outlet device according to claim 2, wherein the body comprises a water inlet member, an water inclining body, a housing, a water distribution plate, and a water outlet panel, the water inlet member is provided with a water inlet, the housing is provided with a seating surface with an opening on the water passing chamber on the seating surface, the water inclining body is seated on the seating surface, the water inlet member is seated on the water inclining body and is fixedly connected to the housing, the water inclining body is provided with a plurality of inclined water holes, a water inlet end and a water outlet end of the inclined water hole are respectively connected to the water inlet and the water passing chamber such that the impeller rotates, the housing is further provided with an installation groove, the water distribution plate is disposed in the installation groove and is provided with a water passing channel connected to the water passing port, the water outlet panel is provided with the water outlet connected to the water passing channel, and the water outlet panel is fixedly connected to the housing and abuts against the water distribution plate, so that two sides of the water distribution plate are respectively limited by the water outlet panel and a groove bottom of the installation groove.
